(19) United States
(12) Patent Application Publication
(10) Pub. No.: US 2009/0050493 A1
(43) Pub. Date: Feb. 26, 2009

(54) Gas Sensor, Fuel Supply System Using the Same, and Method of Using Gas Sensor

(75) Inventors: Keiichi Saji, Aichi-gun (JP); Jiro Sakata, Nagoya-shi (JP); Tadashi Inaba, Seto-shi (JP); Keiichiro Aoki, Susono-shi (JP); Yusuke Suzuki, Susono-shi (JP); Susumu Naitoh, Kariya-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, Toyota-shi, Aichi-ken (JP); DENSO CORPORATION, Kariya-city , Aichi-Pref (JP)

(21) Appl. No.: 12/224,887

(22) PCT Filed: Mar. 15, 2007
(86) PCT No.: PCT/IB2007/000645

§ 371 Date: Sep. 9, 2008

(30) Foreign Application Priority Data
Mar. 17, 2006 (JP) 2006-074547

(51) Int. Cl. G01N 27/40; F02D 41/14

(52) U.S. Cl. 205/793; 204/415; 701/104

(57) ABSTRACT

A gas sensor has a gas diffusion barrier that supports therein a catalyst that catalyzes a reaction between combustible components and oxygen; a solid electrolyte having oxide ion conductivity; and electrodes formed on opposite surfaces of the solid electrolyte. The electrode is formed in a region into which ambient gas diffuses at a rate limited by the gas diffusion barrier. The electrode also catalyzes the reaction between combustible gas and oxygen. The electrode is formed in a region into which atmosphere is introduced.

### BACKGROUND OF THE INVENTION

1. Field of the Invention

The present invention relates to a gas sensor, a fuel supply system using the gas sensor, and a method of using the gas sensor. In particular, the present invention relates to a gas sensor which can obtain electric signals corresponding to the concentrations of oxygen and combustible gas in the gas around the gas sensor (ambient gas), a fuel supply system using the gas sensor, and a method of using the gas sensor.

2 Description of the Related Art

Gas sensors have been developed which can detect the air-fuel ratio of the air-fuel mixture burned in an engine, which installed in an environment through which exhaust gas from the engine passes, and one of the most fundamental examples of such a gas sensor is described in JP-A-2000-131271. The gas sensor of JP-A-2000-131271 has a gas diffusion barrier; a solid electrolyte; and a pair of electrodes. The solid electrolyte has oxide ion conductivity and is of a plate-like shape. Paired electrodes are formed on the surfaces of the solid electrolyte. One of the electrodes is located in a region where ambient gas diffuses at a rate limited by the gas diffusion barrier. The electrode also catalyzes a reaction between oxygen and combustible gas. The other electrode is located outside the region and exposed to atmosphere.

According to the gas sensor described in JP-A-2000-131271, exhaust gas reaches the catalytic electrode with its diffusion rate limited by the gas diffusion barrier. Because the electrode catalyzes the reaction of oxygen and combustible gas contained in the exhaust gas having that reach the electrode, the oxygen concentration in the exhaust gas near the catalytic electrode decreases. Here, a case is described where oxygen remains in the ambient gas after the reaction between the combustible gas and oxygen, that is, the oxygen concentration in the ambient gas is greater than the concentration of the combustible gas (which is referred to as “lean air-fuel ratio”). In a basic sensor in which pair of electrodes are provided on the surfaces of a zirconia solid electrolyte layer and in which a gas diffusion barrier that limits diffusion of ambient gas into the electrodes is provided, the electrode into which ambient gas is introduced (detection electrode) serves as the negative electrode and the electrode exposed to atmosphere serves as the positive electrode. When a predetermined voltage is applied between the two electrodes, the oxygen in the ambient gas is ionized in the detection electrode. The ionized oxygen is conducted to the zirconia solid electrolyte layer as oxide ions. Then, a current flows in an external power supply circuit. In the sensor of this configuration, because oxygen in the ambient gas is introduced into the electrodes with limited by the gas diffusion barrier, the magnitude of the current that flows in the external power supply circuit is proportional to the oxygen concentration. Therefore, by measuring the current, the concentration of oxygen in the exhaust gas can be determined.

When the concentration of combustible gas in the ambient gas is greater than the concentration-of oxygen (which is referred to as “rich air-fuel ratio”), combustible gas remains on the detection electrode. In this case, oxygen is conducted from the electrode on the atmosphere side to the zirconia solid electrolyte layer in the form of oxide ions and supplied to the detection electrode side, and thus reacts with the combustible gas on the detection electrode. Therefore, a current flows in the opposite direction in the power supply circuit, and the concentration of combustible gas can be determined based on the magnitude of the current.

With such a gas sensor, when the ambient gas is combustion exhaust gas, in which combustible gas and oxygen are mixed, an output current corresponding to a lean air-fuel ratio and a rich air-fuel ratio can be obtained. Consequently, the air-fuel ratio of the air-fuel mixture burned in the engine can be determined. The primary components of combustible gas contained in engine exhaust gas are carbon monoxide (CO), hydrogen (H₂) and methane (CH₄), and minute amounts of various other organic compounds are also contained. When an exhaust gas sensor of this type is directly exposed to an environment in which these components and oxygen are mixed in a chemical non-equilibrium state, the accuracy in detecting the air-fuel ratio deteriorates, or the detection accuracy due to degradation of the electrodes deteriorates. Therefore, an additional catalyst layer is provided around the gas sensor in order to prevent deterioration in detection accuracy.

A gas sensor described in JP-A-Hei 11-237361 has a porous coating on one surface of an electrode and provides a catalyst layer outside the porous coating. A catalyst that promotes the reaction of combustible gas and organic compounds with oxygen is supported in the catalyst layer. By providing the catalyst layer, the combustible gas and organic compounds contained in exhaust gas may be reacted with oxygen in the catalyst layer before reaching the catalytic electrode. As a result, the combustible gas and oxygen contained in exhaust gas in a non-equilibrium state are equilibrated before reaching the catalytic electrode. Therefore, the concentrations of the equilibrated combustible gas and oxygen contained in the exhaust gas can be detected precisely. Consequently, the air-fuel ratio can be detected precisely.

Many gas sensors using a zirconia solid electrolyte demonstrate the ability to detect the concentration of a gas component precisely when heated to a temperature of 600° C. or higher. Such gas sensors are usually provided with a heater to bring the sensor to the appropriate temperature. Ordinary heaters heat the gas sensor at a low-rate of approximately 3 to 5° C.(sec. However, to adjust the air-fuel ratio of air-fuel mixture to be supplied to an engine to an appropriate value within a short period of time, the rate of heating the gas sensor needs to be increased. Heaters in recent years can heat a gas sensor at approximately 30° C./sec or higher. As a result, the delay before a gas sensor is able to detect the concentration of components in exhaust gas from an engine precisely is significantly decreased.

However, it has been found that the gas sensor determines that the air-fuel ratio is rich immediately after the start of detection, even when the air-fuel mixture burned in the engine has a stoichiometric air-fuel ratio. It has also been found that as the rate of heating the gas sensor is higher, the above phenomenon is more likely to occur, but gradually disappears after the completion of heating

In general, organic compounds contained in residual exhaust gas are adsorbed in the gas diffusion barrier of gas sensors that employ a gas diffusion barrier when the gas sensor is cold (when the gas sensor is not operating). Therefore, when the gas sensor is reheated to restart the detection with the gas sensor, the organic compounds adsorbed in the gas diffusion barrier are evaporated. Some of the evaporated organic compounds then move onto a surface of the catalytic electrode. The organic compounds that move onto the surface of the catalytic electrode react with oxygen contained in exhaust gas by the catalysis of the electrode. Therefore, the amount of oxygen in the gas contacting with the catalytic electrode decreases. As a result, in a gas sensor that employs a gas diffusion barrier, the electrode is exposed to a higher concentration of combustible gas than is actually present in the exhaust gas, immediately after the heating of the gas sensor.

In an ordinary gas sensor, the organic compounds adsorbed in the gas diffusion barrier are completely evaporated before the gas sensor reaches the operation temperature because the gas sensor is heated at rate of about 3 to 5° C./sec. Therefore, a gas sensor does not detect a concentration of combustible gas higher than the actual concentration that has been influenced by the adsorbed organic compounds, when the gas sensor reaches the operation temperature. However, when the gas sensor is heated at a rapid rate in order to reduce the time needed for the gas sensor to reach the operation temperature, evaporation of the adsorbed organic compounds from the gas diffusion barrier is delayed in comparison.

Incidentally, the residual organic compounds are transformed in a high-temperature environment, and thus their boiling points are raised. Thus, the evaporation is further delayed and the residual organic compounds are eventually carbonized. Therefore, the adsorbed organic compounds do not react with oxygen until the temperature reaches a value equal to or higher than the temperature at which the sensor can operate. As a result, the sensor outputs an electric signal corresponding to a concentration higher than the actual concentration of combustible gas in the exhaust gas for a certain period of time after the start of detection. The above phenomenon occurs not only in the sensor of the type for detecting an electromotive force as described in JP-A-Hei 11-237361 but also in a sensor of the type for detecting a current which flows between electrodes as described in JP-A-2000-131271. This is a phenomenon that is commonly observed in gas sensors that employ a gas diffusion barrier.

The above phenomenon may be confirmed using a gas sensor having the basic configuration as shown in FIG. 1. A gas sensor 10 has a gas diffusion barrier 14, a solid electrolyte 18; and a pair of electrodes 16 and 20, and the concentration of a gas component is detected based on the amount of current that flows between the electrodes 16 and 20. The solid electrolyte 18 has oxide ion conductivity, and is of a plate-like shape. The paired electrodes 16 and 20 are formed on the surfaces of the solid electrolyte 18. A detection chamber 17 is provided between the solid electrolyte 18 and the gas diffusion barrier 14, and is bounded by the gas diffusion barrier 14. The electrode 16 is located in the detection chamber 17, into which exhaust gas diffuses at a rate limited by the gas diffusion barrier 14. The electrode 16 catalyzes the reaction between combustible gas and oxygen. The other electrode 20 is formed in an atmospheric chamber 21. The atmospheric chamber 21 is communicated with atmosphere through a hole (not shown). In the drawing, the reference numeral 12 denotes a dense protective layer that is impermeable to gas, and the reference numeral 22 denotes an insulating sheet in which a heater 24 is formed. The gas sensor 10 is connected to a power supply circuit 26 provided with an ammeter, and is used with a negative voltage applied to the electrode 16 and a positive voltage applied to the electrode 20. The gas sensor 10 is a limiting-current 10 sensor, and the value of the current flowing through it varies depending on the concentrations of combustible gas and oxygen.

Several gas sensors 10 were produced and tested under the three conditions shown below. (1) The gas sensor 10 was exposed to a nitrogen (N₂) atmosphere containing 0.1% of hydrogen (H₂) and 10% of water vapor (H₂O) for two hours. Then, the gas sensor 10 was placed in 100% nitrogen atmosphere, a voltage of 0.45 V was applied to the power supply circuit 26, and the heater 24 was turned on. (2) The gas sensor 10 was exposed to a nitrogen atmosphere containing 100 ppm of ethanol (C₂H₅OH), 10% of water vapor and 10% of oxygen (O₂) for one hour. Then, the gas sensor 10 was placed in 100% nitrogen atmosphere, a voltage of 0.45 V was applied to the power supply circuit 26, and the heater 24 was turned on. (3) The gas sensor 10 was exposed to a nitrogen atmosphere containing 100 ppm of 2-methoxyethanol (CH₃OCH₂CH₂OH), 10% of water vapor and 10% of oxygen (O₂) for one hour. Then, the gas sensor 10 was placed in 100% nitrogen atmosphere, a voltage of 0.45 V was applied to the power supply circuit 26, and the heater 24 was turned on.

FIG. 9 shows the results of the above tests (1) to (3). The left vertical axis represents the-value of the current (mA) that flowed in the power supply circuit 26, the right vertical axis represents the temperature (° C.) of the gas sensor 10, and the horizontal axis represents the time period (seconds) elapsed after the heater 24 was turned on. The curve 72 represents the temperature of the gas sensor 10. The curve 78 represents the value of the current that flowed in the power supply circuit 26 under the condition (1). The curve 76 represents the value of the current that flowed in the power supply circuit 26 under the condition (2). The curve 74 represents the value of the current that flowed in the power supply circuit 26 under the condition (3). Because more oxygen is consumed as the concentration of combustible gas in the detection chamber 17 is higher, and the amount of organic compounds remaining in the gas diffusion barrier 14 is greater, a negative current value with a greater absolute value flows through the ammeter provided in the power supply circuit 26.

The curve 72 indicates that the gas sensors 10 were heated at a rate of 30° C./soc or higher to approximately 650° C. The curve 78 indicates that a current indicating the existence of combustible gas did not flow under the condition (1). When tests were conducted under the same condition as the condition (1) except that carbon monoxide (CO) and propane (C₃H₈) were respectively used instead of hydrogen, no current indicating the existence of combustible gas was generated. The curve 76 indicates that a peak current of −0.3 mA indicating the existence of combustible gas flowed approximately 11 seconds after the heater 24 was turned on under the condition (2). In the gas sensors 10 for the tests, a peak current of −0.3 mA corresponds to an air-fuel ratio equivalent to an air excess ratio of approximately 0.9 (which means that the amount of air is 10% smaller than required to achieve the theoretical air-fuel ratio with respect to the amount of fuel).

That is, a rich air-fuel ratio was detected despite the fact that the test was conducted in 100% nitrogen atmosphere. The curve 74 indicates that a peak current of −0.7 mA indicating the existence of combustible gas flowed approximately 12 seconds after the heater 24 was turned on under the condition (3). A peak current of −0.7 mA corresponds to an air-fuel ratio equivalent to an air excess ratio of approximately 0.8.

It was confirmed through the tests that when the gas sensor 10 is heated with a heater that heats the gas sensor 10 at a rate of approximately 30° C./sec or higher, ethanol and 2-methoxyethanol adsorbed in the gas diffusion barrier 14 of the gas sensor 10 are evaporated with an increase in the temperature of the gas sensor 10, but output indicating a rich air-fuel-ratio is generated at a temperature much higher than the boiling point of ethanol, 78° C., and the boiling point of 2-methoxyethanol, 124° C. Even when the gas sensor 10 is exposed to combustible gas such as hydrogen, carbon monoxide or propane while the gas sensor 10 is not operating as described in the condition (1), erroneous detection does not occur immediately after heating. The points here are the existence of organic components which may be adsorbed in the gas diffusion barrier as described in condition (2) and condition (3) and the fact that the gas existing in the exhaust pipe after the engine is stopped contains a minute amount of organic compounds which may be adsorbed in the gas diffusion barrier.

These points are true not only for limiting-current gas sensors. When heated rapidly, gas sensors of the type for detecting an electromotive force output an electric signal corresponding to a concentration which is higher than the actual concentration of combustible gas immediately after heating. It is assumed that a phenomenon in which combustible gas and organic compounds adsorbed in the gas diffusion barrier are evaporated with an increase in the temperature of the gas sensor and transferred to the detection chamber occurs in ordinary gas sensors. In these gas sensors, however, the organic compounds adsorbed in the gas diffusion barrier are completely evaporated before the gas sensor reaches the operation temperature because the rate of heating the gas sensors is low. Therefore, when the gas sensor reaches the operation temperature, detection of a concentration higher than the actual concentration caused by adsorbed organic compounds hardly occurs.

### SUMMARY OF THE INVENTION

The present invention prevents detection errors that may occur when a gas sensor is rapidly heated. The detection errors may occur due to the evaporation of organic compounds adsorbed in a gas diffusion barrier when the gas sensor is rapidly heated. When this gas sensor is used, the air-fuel ratio of an air-fuel mixture is precisely controlled, and the air-fuel mixture may be supplied to an engine from an early stage of operation of the engine.

The present invention provides a gas sensor in which organic compounds adsorbed in a gas diffusion barrier while the gas sensor is cold are not introduced into a detection chamber when the gas sensor is heated. The gas sensor has a gas diffusion barrier; a solid electrolyte; and paired electrodes. The gas diffusion barrier supports a catalyst that promotes a reaction between oxygen and organic compounds. The solid electrolyte has oxide ion conductivity, and is of a plat-like shape. The paired electrodes are formed on the surfaces of the solid electrolyte. One of the paired electrodes is located in a region into which ambient gas diffuses at a rate limited by the gas diffusion barrier, and catalyzes the reaction between the organic compounds and oxygen. The other electrode is located outside the region into which ambient gas diffuses.

In the gas sensor of the present invention, a catalyst that promotes the reaction between oxygen and organic compounds is supported in the gas diffusion barrier. Therefore, even if combustible components such as organic compounds are adsorbed in the gas diffusion barrier when the gas sensor is cold, some of the organic compounds reacts with oxygen and is decomposed. In addition, when the gas sensor is reheated, the organic compounds adsorbed in the gas diffusion barrier react with oxygen while the temperature of the gas sensor is still below the operational temperature of the gas sensor. Therefore, the concentration of combustible gas is not detected as higher than the actual value when the detection with the gas sensor is restarted.

In the gas sensor of the present invention, the catalyst supported in the gas diffusion barrier and a porous catalyst layer around the gas sensor is preferably formed of metal particles composed primarily of at least one metal element selected from the group including platinum, ruthenium, palladium and rhodium. In the above gas sensor, the degree of activity of the catalyst is high. Therefore, combustible gas and organic compounds can react with oxygen efficiently.

The density of the catalyst supported on the side of the gas diffusion barrier that faces ambient gas may be relatively high and the density of the catalyst supported on the side of the gas diffusion barrier that faces an electrode housing space may be relatively low. Because the catalyst also tends to adsorb oxygen while the gas sensor is cold, when the density of supported catalyst is too high, a large amount of oxygen is adsorbed in the catalyst. When the gas sensor is reheated the adsorbed oxygen is desorbed from the catalyst and moves to a surface of the catalytic electrode. Then, when the gas sensor is resumed detecting, the detected concentration of combustible gas may be lower than the actual value. Therefore, the density of the catalyst supported on the side of the gas diffusion barrier that faces ambient gas is relatively high so that organic compounds react with oxygen efficiently when the gas sensor is not operating, and the density of the catalyst supported on the side of the gas diffusion barrier that faces an electrode housing space is relatively low in order to reduce the amount of oxygen that is desorbed from the catalyst and moves to a surface of the catalytic electrode when the gas sensor is reheated.

The gas sensor of the present invention may further include a catalyst support layer provided outside the gas diffusion barrier that faces ambient gas. In the above gas sensor, the difference between the density of catalyst supported on the side of the gas diffusion barrier that faces the ambient gas and the density of catalyst supported on the side of the gas diffusion barrier that faces the electrode housing space is large. In addition, the phenomenon in which combustible components, such as organic compounds, are adsorbed in the gas diffusion barrier when the gas sensor is cold can be suppressed. Therefore, because adsorption of organic compounds in the electrodes can be decrease the durability (life duration) of the gas sensor is improved.

The catalyst for promoting a reaction between oxygen and combustible components is supported in the gas diffusion barrier at a density in the range of 6.25 to 125 mg/cm³. When the density of the catalyst is within the above range, organic compounds react with oxygen sufficiently while the gas sensor is not operating. Also, the influence of oxygen which is desorbed when the gas sensor is heated, and the deterioration of responsiveness may be suppressed, which is caused by such as, adsorption of combustible gas and oxygen into the catalyst when passing through the gas diffusion barrier during the operation of the gas sensor, or by the catalyst obstructing the passing of combustible gas and oxygen.

According to the present invention, a fuel supply system can be also provided. The fuel supply system has, in addition to the above gas sensor, a heater that heats the gas sensor at a rate of approximately 30° C./sec or higher. In addition, the fuel supply system has a current detection means for detecting the current that flows between the paired electrodes; and a control device for controlling the amount of fuel supplied based on the amount of current detected by the current detection means.

In the above fuel supply system, the gas sensor detects the concentration of combustible gas precisely within a short period of time. Therefore, the air-fuel ratio of. the air-fuel mixture to be supplied to the engine can be adjusted to an appropriate value based on amount of current detected by the current detection means within a short period of time after the engine starts.

The present invention also provides a method of using the gas sensor to improve the durability (life duration) of the gas sensor. Specifically, the gas sensor is heated up to a predetermined temperature at prescribed time intervals to react organic compounds adsorbed in the gas diffusion barrier with oxygen. By this method, accumulation of combustible components in the gas diffusion barrier is prevented Combustible components such as organic compounds may be carbonized when burned with insufficient oxygen. Once carbonated, the combustible components accumulate in the gas diffusion barrier. As a result, when the gas sensor reaches a high temperature, the accumulated combustible components react with oxygen, and the gas sensor cannot detect the concentration of the target gas component precisely. However, according to the above method, the combustible components adhered to the gas diffusion barrier are periodically reacted with oxygen. Therefore, because increase of adsorption amount of combustible components adsorbed in the gas diffusion barrier over a long period of time is prevented, accumulation of carbides in the gas diffusion barrier does not increase. As a result; the gas sensor detects the concentration of the target gas component precisely over a long period of time.

According to the gas sensor of the present invention, erroneous detection of air-fuel ratio by the gas sensor in the early stage of operation of the gas sensor is prevented. In addition, when the gas sensor of the present invention is used, a fuel supply system that can detect the air-fuel ratio precisely and control the amount of fuel to be supplied to the engine properly from the time immediately after the start of the engine can be provided.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 illustrates the basic structure of a gas sensor.

FIG. 2 illustrates a gas sensor according to a second embodiment of the present invention.

FIG. 3 schematically illustrates a fuel supply system.

FIG. 4 illustrates a modification of the gas sensor.

FIG. 5 is a graph showing the results of Example 1.

FIG. 6 is a graph showing the results of Example 2.

FIG. 7 is a graph showing the results of both Example 1 and Example 2.

FIG. 8 is a graph showing the results of Example 3.

FIG. 9 is a graph showing the results of tests conducted using conventional gas sensors.

### DETAILED DESCRIPTION OF THE PREFERRED EMBODIMENT

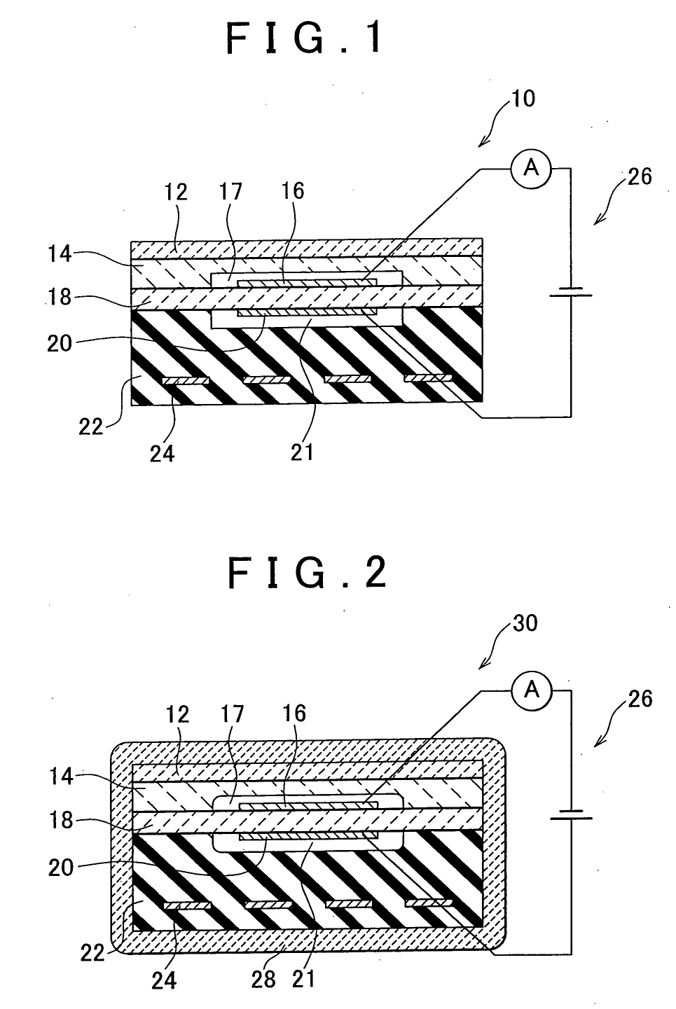

FIG. 1 schematically illustrates the basic structure of a gas sensor as described above. The gas sensor 10 has a gas diffusion barrier 14; a solid electrolyte 18; and a pair of electrodes 16 and 20. The solid electrolyte 18 has oxide ion conductivity, and is of a plate-like shape. The paired electrodes 16 and 20 are formed on the surfaces of the solid electrolyte 18. A detection chamber 17 is provided between the solid electrolyte 18 and the gas diffusion barrier 14, and is bounded by the gas diffusion barrier 14. The electrode 16 is located in the detection chamber 17, into which exhaust gas diffuses at a rate limited by the gas diffusion barrier 14. The electrode 16 catalyzes the reaction between combustible gas and oxygen. The other electrode 20 is formed in an atmospheric chamber 21. The atmospheric chamber 21 is communicated with atmosphere through a hole (not shown). In the drawing, the reference numeral 12 denotes a dense protective layer that is impermeable to gas, and the reference numeral 22 denotes an insulating sheet in which a heater 24 is formed. The gas sensor 10 is connected to a power supply circuit 26 provided with an ammeter, and is used with a negative voltage applied to the electrode 16 and a positive voltage applied to the electrode 20.

The gas diffusion barrier 14 is made of porous alumina, and limits the diffusion rate of the gas around the gas sensor 10 into the detection chamber 17. The gas diffusion barrier 14 in this embodiment supports therein a catalyst that promotes the reaction between oxygen and combustible components. The catalyst is formed of metal particles composed primarily of platinum. In place of platinum, at least one metal element selected from the group including ruthenium, palladium and rhodium may be used. Alternatively, the catalyst may be formed of a mixture of metal particles composed primarily of platinum and metal particles composed primarily of at least one metal element selected from the group including ruthenium, palladium and rhodium. The solid electrolyte 18 has oxide ion conductivity, and made of a zirconia solid electrolyte. The zirconia solid electrolyte is made of a solid solution in which 3 to 10 mol % of yttria (Y₂O₃), magnesia (Mg₂O₃) or calcia (Ca₂O₃) is dispersed in zirconia (ZrO₂). The electrode 16 and the electrode 20 are made of a metal composed primarily of platinum. In place of platinum, an alloy or mixture of platinum and at least one metal element, belonging to the platinum group other than platinum, which is selected from the group including gold, silver and nickel may be used. Alternatively, the electrode may be made of an alloy or mixture of platinum and at least one metal element selected from the group including ruthenium, palladium and rhodium. Particles of a zirconia solid electrolyte, or alumina or another oxide may be mixed in the electrode metal. The heater 24 is connected to an external electrode (not shown) and heats the gas sensor 10 at a rate of approximately 30° C./sec or higher.

The method of detecting the air-fuel ratio with the gas sensor 10 is described. When the gas sensor 10 is installed in a space in which exhaust gas (mixed gas of combustible gas and oxygen) exists, the exhaust gas passes through the gas diffusion barrier 14 with its diffusion rate limited and is introduced into the detection chamber 17, in which the electrode 16 is formed. Since the electrode 16 has catalysis for inducing a reaction between combustible gas and oxygen, combustible gas reacts with oxygen on a surface of the electrode 16. In this case, when the exhaust gas is rich, combustible gas remains in the detection chamber 17 after the reaction with oxygen. When the power supply circuit 26 is turned on, oxygen is introduced from the atmospheric chamber 21 into the detection chamber 17 through the solid electrolyte 18. The amount of oxygen that is introduced into the detection chamber 17 is equal to the amount of oxygen reacted with the combustible gas. When the amount of oxygen introduced into the detection chamber 17 is measured, the amount of combustible gas contained in the exhaust gas existing around the gas sensor 10 can be determined. The amount of oxygen that is introduced into the detection chamber 17 is proportional to the current that flows between the electrodes 16 and 20. Thus, by reading the value of the current flowing in the power supply circuit 26, the concentration of combustible gas in the exhaust gas can be determined

As the concentration of combustible gas in the detection chamber 17 is higher, a negative current with a larger absolute value flows through the ammeter provided in the power supply circuit 26. A negative current value indicates that the air-fuel ratio of air-fuel mixture burned in the engine is rich. When the concentration of combustible gas in the detection chamber 17 is low, oxygen remains in the detection chamber 17 after the reaction, and a positive current with a large absolute value is caused to flow through the solid electrolyte 18 from the electrode 16 to the electrode 20 and then through the ammeter provided in the power supply circuit 26 by the power supply circuit 26. A positive current value indicates that the air-fuel ratio of the air-fuel mixture burned in the engine is lean. When the concentration of combustible gas and oxygen in exhaust gas are determined, the air-fuel ratio of air-fuel mixture burned in the engine can be determined. When the gas sensor 10 is used, erroneous determination of a rich state can be prevented after the start of operation.

FIG. 2 schematically illustrates a gas sensor 30 of a second embodiment. In the gas sensor 30, a porous catalyst layer 28 is formed around the gas sensor 10. Other parts are the same as those of the gas sensor 10. Only the catalyst layer 28 is hereinafter described, and the description of other parts is not repeated. The catalyst layer 28 supports therein a catalyst that induces the reaction between combustible components and oxygen. Also, the catalyst layer 28 is made of porous alumina, and combustible gas and oxygen can pass through the catalyst layer 28. In the gas sensor 30, a catalyst is supported in the catalyst layer 28 as well as in the gas diffusion barrier 14. Therefore, the density of catalyst supported on the side of the gas diffusion barrier 14 that faces ambient gas is further increased and the density of catalyst supported on the side of the gas diffusion barrier 14 that faces the detection chamber 17 is kept low. Also, because organic compounds adsorbed in the catalyst layer 28 while the gas sensor is cold react with oxygen, the adsorption of combustible components in the gas diffusion barrier 14 can be prevented. Because the method of detecting the air-fuel ratio of exhaust gas using the gas sensor 30 is substantially the same as in the case of the gas sensor 10, redundant description is not repeated.

FIG. 4 illustrates a modification of the gas sensor 30. The description about the substantially same components with those of the gas sensor 30 is not repeated. In the gas sensor 130, a gas diffusion barrier 114 is formed in a part of a dense protective layer 112. The gas diffusion barrier 114 supports therein a catalyst that promotes the reaction between oxygen and combustible components. A catalyst layer 128 is formed on an upper part of the protective layer 112 and covers the gas diffusion barrier 114. In the gas sensor 130, because the gas diffusion barrier 114 has a small diameter, the region through which combustible gas and oxygen can pass is limited. Also, the amount of organic compounds that are adsorbed when the detection operation is not conducted is decreased. Therefore, the amount of catalyst supported in the gas diffusion barrier 114 is reduced. Because catalysts are expensive, if the amount of the supported catalyst is reduced, the gas sensor may be produced inexpensively. The description of the method determining the air-fuel ratio of exhaust gas using the gas sensor 130 is not repeated because it is substantially the same as in the case of the gas sensor 10.

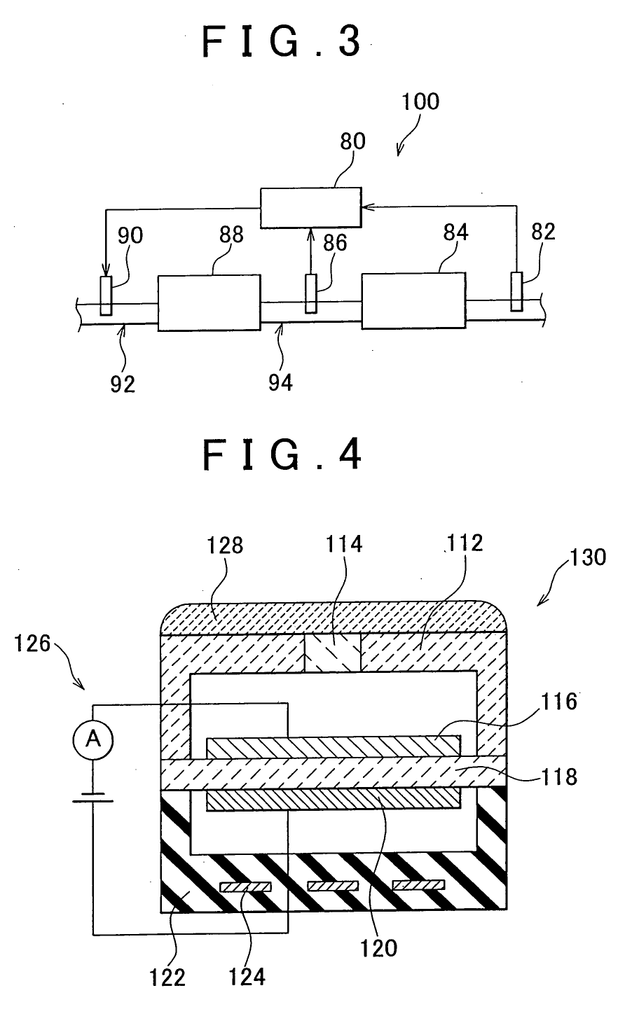

FIG. 3 is a schematic view of a fuel supply system 100 provided with a gas sensor of the present invention. The fuel supply system 100 has an engine 88; an exhaust emission control device (three-way catalyst) 84; a control device 80; gas sensors 82 and 86; and a fuel injector 90. The engine 88 has an intake pipe 92 on the intake side (the side on which fuel is supplied to the engine 88), and the fuel injector 90 is disposed in the intake pipe 92. Also, the engine 88 has an exhaust pipe 94 on the exhaust side (the side on which exhaust gas is discharged from the engine 88), and the gas sensor 86, the exhaust emission control device 84 and the gas sensor 82 are disposed in the exhaust pipe 94. The gas sensors 82 and 86 are located on both sided of the exhaust emission control device 84. The control device 80 receives electric signals from the gas sensors 82 and 86 and controls the fuel injector 90.

Exhaust gas discharged from the engine 88 is discharged into the outside air through the exhaust emission control device 84. Here, the gas sensor 86 detects the concentrations of combustible gas and oxygen in the exhaust gas discharged from the engine 88. The gas sensor 82 detects the concentrations of combustible gas and oxygen in the exhaust gas that passes through the exhaust emission control device 84. The control device 80. receives electric signals from the gas sensors 82 and 86 and detects the concentration of combustible gas and oxygen in the exhaust gases. As a result, the control device 80 determines the appropriateness of the air-fuel ratio of the air-fuel mixture burned in the engine 88. Then, the control device 80 controls the operation of the fuel injector 90 so as to achieve a desired air-fuel ratio or lean combustion air-fuel ratio). The above fuel supply system 100 changes the air-fuel ratio of the air-fuel mixture to be burned in the engine 88 by controlling the operation of the fuel injector 90 even when the desired air-fuel ratio is changed depending on the temperature of the engine 88 or the load on the engine 88.

Examples are described in detail with reference to the drawings.

The gas sensor 30 shown in FIG. 2 was produced. That is, a paste for forming platinum electrode was screen-printed on both surfaces of a thin-plate unfired zirconia solid electrolyte 18. Then, an unfired insulating sheet 21 in which the heater 24 is formed, a gas diffusion barrier 14 made of unfired porous alumina, and a dense protective layer 12 were prepared and bonded together after that, firing was carried out at 1480° C. for two hours to integrate them. The detection part of the gas sensor after firing had a size of 15 mm length×4.6 mm width×1.6 mm thickness. Slurry obtained by mixing 70 g of γ alumina, 10 g of alumina hydrate, 20 g of aluminum nitrate and water was applied to a part around the detection part of the gas sensor integrated by firing. Then, the gas sensor was dried at 100° C., followed by firing at 900° C. for one hour to form a porous catalyst layer 28. Consequently, the obtained catalyst layer 28 had a thickness of 0.2 mm, and the detection part had a volume of 0.04 cm³.

Five gas sensors 30 were prepared. Then, different amounts of an aqueous solution of chloroplatinic acid (H₂PtCl₆) is instilled into the parts of the catalyst layers 28 and the gas diffusion barrier 14 through which combustible components pass, followed by drying and firing, and thereby five gas sensors (1) to (5)that differ only in the amount of platinum catalyst supported in the catalyst layer 28 and the gas diffusion barrier 14 of each sensor were prepared. For comparison, a gas sensor in which no platinum catalyst is supported was also prepared. The amount (mg) of supported platinum catalyst, and the density (mg/cm³) of supported platinum catalyst in the catalyst layer 28 and the gas diffusion barrier 14 for each sensor are shown below.

(1) Platinum catalyst amount 0 mg (0 mg/cm³)
(2) Platinum catalyst amount 0.05 mg (1.25 mg/cm³)
(3) Platinum catalyst amount 0.25 mg (6.25 mg/cm³)
(4) Platinum catalyst amount 1 mg (25 mg/cm³)
(5) Platinum catalyst amount 5 mg (125 mg/cm³)

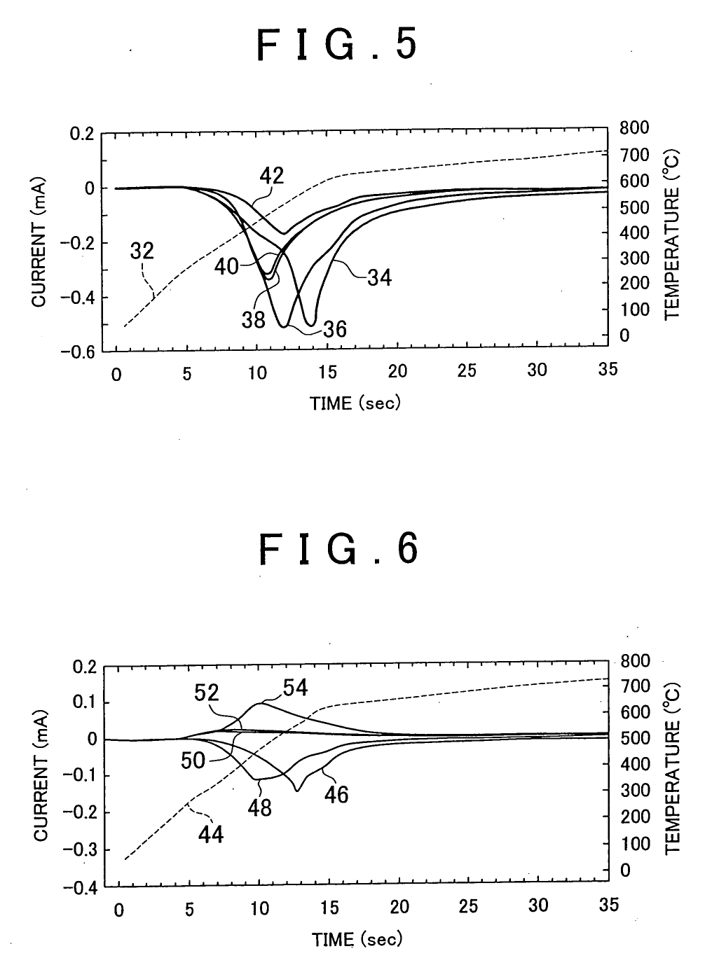

The above gas sensors 30 (1) to (5) were exposed to a nitrogen gad atmosphere containing 100 ppm of 2-methoxyethanol (CH₃OCH₂CH₂OH), 10% of water vapor (H₂O) and 20% of oxygen (O₂) for one hour. Then, under a 100% nitrogen gas atmosphere, a voltage of 0.45 V was applied to the power supply circuit 26 and the heater 24 was turned on. In FIG. 5, the left vertical axis represents the value of the current (mA) that flowed in the power supply circuit 26, the right vertical axis represents the temperature of the gas sensor 30, and the horizontal axis represents the time period (seconds) elapsed after the heater 24 was turned on. The curve 32 represents the temperature of the gas. sensor 30. The curve 34 represents the value of the current that flowed in the power supply circuit 26 when the gas sensor (1) was used. The curve 36 represents the value of the current that flowed in the power supply circuit 26 when the gas sensor (2) was use& The curve 38 represents the value of the current that flowed in the power supply circuit 26 when the gas sensor (3) was used. The curve 40 represents the value of the current that flowed in the power supply circuit 26 when the gas sensor (4) was used. The curve 42 represents the value of the current that flowed in the power supply circuit 26 when the. gas sensor (5) was used.

The curve 32 indicates that the gas sensors 30 were heated at a rate of 30° C./sec or higher to approximately 600° C., and then its temperature was raised slowly. The curve 34 indicates that a peak current of −0.5 mA indicating the existence of combustible gas flowed approximately 14 seconds after the heater 24 was turned on. A peak current of −0.5 mA corresponds to an air-fuel ratio equivalent to an air excess ratio of approximately 0.84. In addition, it took approximately 30 seconds for the current value to reach a value close to 0 mA (which corresponds to an air-fuel ratio equivalent to an air excess ratio of 1.0) after the heater 24 was turned on.

The curve 36′ indicates that a peak current of −0.5 mA indicating the existence of combustible gas flowed approximately 12 seconds after the heater 24 was turned on. In addition, it took approximately 30 seconds for the current value to reach a value close 0 mA after the heater 24 was turned on. A current flowed with the same magnitude as that in the case where platinum was not supported in the parts of the catalyst layer 28 and the gas diffusion barrier 14 through which detection target gas would pass. This indicates that when the density of platinum supported in the catalyst layer 28 and the gas diffusion barrier 14 is 1.25 mg/cm³, the amount of supported platinum is insufficient to control the negative output current caused by 2-methoxyethanol adhered to the catalyst layer 28 and the gas diffusion barrier 14.

The curve 38 indicates that a peak current of −0.35 mA indicating the existence of combustible gas flowed approximately 11 seconds after the heater 24 was turned on. A peak current of −0.35 mA corresponds to an air-fuel ratio equivalent to an air excess ratio of approximately 0.91. However, as compared to the curve 34 (the density of supported platinum: 0 mg/cm³), the peak current was suppressed to approximately 70%. In addition, the current value reached a value close to 0 mA approximately 20 seconds after the heater 24 was turned on. That is, when the density of platinum supported in the catalyst layer 28 and the gas diffusion barrier 14 is 6.25 mg/cm³, the peak current value of the negative current indicating the existence of combustible gas can be significantly reduced; thus significantly reducing the delay before the gas sensor 30 is able to detect the air-fuel ratio of the ambient gas precisely.

The curve 40 indicates that a peak current of −0.3 mA indicating the existence of combustible gas flowed approximately 11 seconds after the heater 24 was turned on. A peak current of −0.3 mA corresponds to an air-fuel ratio equivalent to an air. excess ratio of approximately 0.9. As compared to the curve 34, the peak current was suppressed to approximately 60%. In addition, the current value reached a value close to 0 mA approximately 20 seconds after the heater 24 was turned on. That is, as in the case of the cure 38, when the density of platinum supported in the catalyst layer 28 and the gas diffusion barrier 14 is 25 mg/cm³, the peak current value of the negative current indicating the existence of combustible gas can be significantly reduced; thus significantly reducing the delay before the gas sensor 30 is able to detect the air-fuel ratio of the ambient gas precisely.

The curve 42 indicates that a peak current of −0.15 mA indicating the existence of combustible gas flowed approximately 12 seconds after the heater 24 was turned on. A peak current of −0.15 mA corresponds to an air-fuel ratio equivalent to an air excess-ratio of approximately 0.45. In addition, the current value reached a value close to 0 approximately 17 seconds after the heater 24 was turned on. That is, as in the case of the curves 38 and 40, when the density of platinum supported in the catalyst layer 28 and the gas diffusion barrier 14 is 125 mg/cm³, the peak current value of the negative current indicating the existence of combustible gas can be significantly reduced; thus significantly reducing the delay before the gas sensor 30 is able to detect the air-fuel ratio of the ambient gas precisely.

The above test results indicate that the density of platinum supported in the catalyst layer 28 and the gas diffusion barrier 14 is 6.25 mg/cm or greater, the peak current value of the negative current indicating the existence of combustible gas can be significantly reduced, thus significantly reducing the delay before the gas sensor 30 is able to detect the air-fuel ratio of the ambient gas precisely.

Five gas sensors 30 of the same type as those in First Example were prepared. In this example, the gas sensors 30 (1) to (5) were exposed to a nitrogen gas atmosphere containing 100 ppm of 2-methoxyethanol, 10% of water vapor and 20% of oxygen for one hour. Then the gas sensors 30(1) to (5) were allowed to stand in atmosphere for 14 days. After that, under a 100% nitrogen gas atmosphere, a voltage of 0.45 V was applied to the power supply circuit 26 and the heater 24 was turned on. In FIG. 6, the left vertical axis represents the value of the current (mA) that flowed in the power supply circuit 26, the right vertical axis represents the temperature of the gas sensor 30, and the horizontal axis represents the time period (seconds) elapsed after the heater 24 was turned on. The curve 44 represents the temperature of the gas sensor 30. The curve 46 represents the value of the current that flowed in the power supply circuit 26 under condition (1), the curve 48 represents the value of the current that flowed in the power supply circuit 26 under condition (2), the curve 50 represents the value of the current that flowed in the power supply circuit 26 under condition (3), the curve 52 represents the value of the current that flowed in the power supply circuit 26 under condition (4), and the curve 54 represents the value of the current that flowed in the power supply circuit 26 under condition (5).

The curve 44 indicates that the gas sensors 30 were heated at a rate of 30° C./sec or-higher to approximately 600° C., and then its temperature was raised slowly. The curve 46 indicates that a peak current of −0.15 mA indicating the existence of combustible gas flowed approximately 13 seconds after the heater 24 was turned on. A peak current of −0.15 mA corresponds to an air-fuel ratio equivalent to an air excess ratio of approximately 0.95. In addition, it took approximately 22 seconds for the current value to reach a value close to 0 mA after the heater 24 was turned on. This indicates that the combustible components adsorbed-in the-parts of the catalyst layer 28 and the gas diffusion barrier 14, through which detected gas would pass were not desorbed even if the gas sensor was allowed to stand in atmosphere for 14 days but was adsorbing a minute amount of combustible components contained in the atmosphere.

The curve 48 indicates that a peak current of −0.12 mA indicating the existence of combustible gas flowed approximately 10 seconds after the heater 24 was turned on. In addition, it took approximately 22 seconds for the current value to reach a value close to 0 mA after the heater 24 was turned on. A current flowed with a magnitude generally equal to that in the case where platinum was not supported in the parts of the catalyst layer 28 and the gas diffusion barrier 14 through which detection target gas would pass. This indicates that when the density of platinum supported in the parts of the catalyst layer 28 and the gas diffusion barrier 14 is 1.25 mg/cm³, the amount of supported catalyst is insufficient and combustible components are adsorbed in the gas diffusion barrier 14 while the gas sensor 30 is not operating;

In the case of the curves 50 and 52, a peak current indicating the existence of combustible gas did not flow before the temperature of the gas sensor 30 was increased sufficiently after the heater 24 was turned on. This indicates that the combustible components adsorbed in the parts of the catalyst layer 28 and the gas diffusion barrier 14 through which detection target gas would pass, reacted with oxygen adsorbed in the platinum catalyst while the gas sensor was allowed to stand in atmosphere and that the amount of excess oxygen adsorbed in the platinum catalyst was small.

The curve 54 indicates that a peak current of plus 0.1 mA, indicating the existence of oxygen, flowed approximately 10 seconds after the heater 24 was turned on. In addition, it took approximately 18 seconds for the current value to reach a value close to 0 mA after the heater 24 was turned on. The curve indicates that the combustible components adsorbed in the parts of the catalyst layer 28 and the gas diffusion barrier 14, through which detection target gas would pass, reacted with oxygen adsorbed in the platinum catalyst while the gas sensor was allowed to stand in atmosphere and excess oxygen was adsorbed in the platinum catalyst. The above test results indicate that when the density of platinum supported in the catalyst layer 28 and the gas diffusion barrier 14 is 125 mg/cm³ or greater, excess oxygen is adsorbed in the platinum catalyst when the gas sensor 30 is left in atmosphere for a long period of time. Therefore, when the gas sensor 30 is reheated the oxygen adsorbed in the platinum is desorbed; thus an electric signal indicating an amount of oxygen in excess of the actual amount is output.

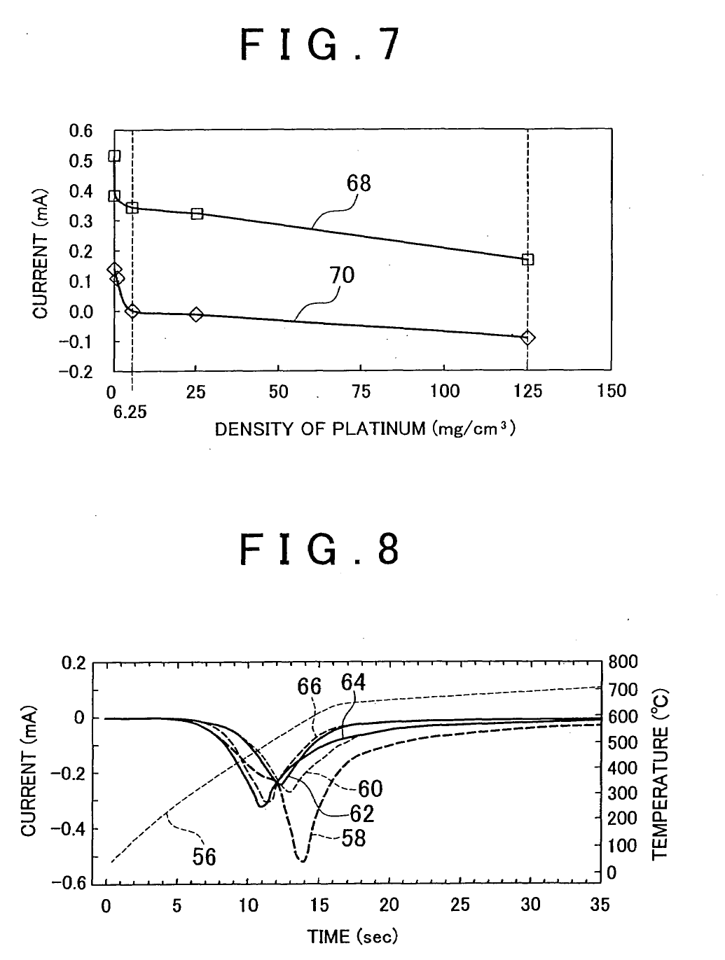

FIG. 7 is a graph in which the results of peak currents obtained in First Example and the results of peak currents obtained in Second Example are shown. The negative peak current value and the positive peak current value are reversed That is, the negative current values in FIG. 5 and FIG. 6 are shown as positive values in FIG. 7, and the positive current values in FIG. 5, FIG. 6 are shown as negative values in FIG. 7. The vertical axis represents the value of the current (mA) that flowed in the power supply circuit 26, and the horizontal axis represents the density of platinum (mg/cm³) supported in the catalyst layer 28 and the gas diffusion barrier 14.

The curve 68 shows the results of First Example (exposed to a nitrogen gas atmosphere containing 100 ppm of 2-methoxyethanol, 10% of water vapor and 20% of oxygen for one hour and measured in 100nitrogen gas atmosphere), and the curve 70 shows the results of Second Example (exposed to a nitrogen gas atmosphere containing 100 ppm of 2-methoxyethanol, 10% of water vapor and 20% of oxygen for one hour and then allowed to stand in atmosphere for 14 days, and measured in 100% nitrogen gas atmosphere). The curve 68 or the curve 70 indicates that when the density of platinum supported in the catalyst layer 28 and the gas diffusion barrier 14 is 6.25 mg/cm³ or greater, the current indicating the existence of combustible gas is significantly decreased.

The curve 70 indicates that the density of platinum supported in the catalyst layer 28 and the gas diffusion barrier 14 is 125 mg/cm³ or smaller, the adsorption of excess oxygen in the catalyst can be suppressed to a practical level even when the gas. sensor 30 is left in atmosphere for a long period of time. Also, it was found that when platinum at the density in the range of 6.25 to 125 mg/cm³ is supported in the catalyst layer 28 and the gas diffusion barrier 14, the current indicating the existence of combustible gas is significantly decreased and a current indicating the existence of excess oxygen is prevented from flowing.

In the gas sensor 30 shown in First Example, the metal element for the catalyst was changed with the density of supported catalyst (platinum, in First Example) maintained at 25 mg/cm³ (1.0 mg) to produce four gas sensors 30. For comparison, a gas sensor 30 in which no platinum catalyst was supported was also produced The metal elements for the catalyst and the amount of catalyst supported in the produced gas sensors 30 are shown below.

(1) No catalyst supported

### (2) Platinum 1.0 mg

(3) Platinum 0.8 mg, ruthenium (Ru) 0.2 mg
(4) Platinum 0.8 mg, palladium (Pd) 0.2 mg
(5) Platinum 0.8 mg, rhodium (Rh) 0.2 mg

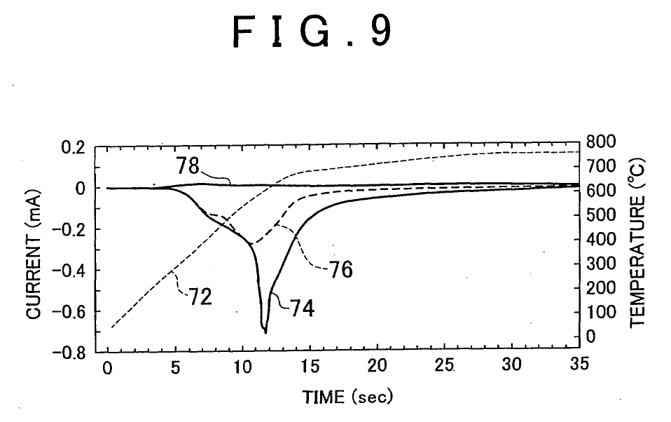

The above gas sensors 30(1) to (5) were exposed to a nitrogen gad atmosphere containing 100 ppm of 2-methoxyethanol (CH₃OCH₂CH₂OH, 10% of water vapor and 20% of oxygen for one hour. Then, under a 100% nitrogen gas atmosphere, a voltage of 0.45 V was applied to the power supply circuit 26 and the heater 24 was turned on. In FIG. 8, the left vertical axis represents the value of the current (mA) that flowed in the power supply circuit 26, the right vertical axis represents the temperature of the gas sensor 30, and the horizontal axis represents the time period (seconds) elapsed after the power supply circuit 26 was turned on. The curve 56 represents the temperature of the gas sensor 30. The cave 58 represents the value of the current that flowed in the power supply circuit 26 when the gas sensor (1) was use& The curve 64 represents the value of the current that flowed in the power supply circuit 26 when the gas sensor (2) was used. The curve 62 represents the value of the current that flowed in the power supply circuit 26 when the gas sensor (3) was used. The curve 60 represents the value of the current that flowed in the power supply circuit 26 when the gas sensor (4), was used. The curve 66 represents the value of the current that flowed in the power supply circuit 26 when the gas sensor (5) was used.

The curve 56 indicates that the gas sensors 30 were heated at a rate of 30° C./sec or higher to approximately 600° C., and then its temperature was raised slowly. The curve 58 indicates that a peak current of −0.5 mA indicating the existence of combustible gas, flowed approximately 14 seconds after the heater 24 was turned on. A peak current of −0.5 mA corresponds to an air-fuel ratio equivalent to an air excess ratio of approximately 0.84. In addition, it took approximately 30 seconds for the current value to reach a value close to 0 mA after the heater 24 was turned on.

The curve 64 indicates that a peak current of −0.3 mA indicating the existence of combustible gas, flowed approximately 11 seconds after the heater 24 was turned on. A peak current of −0.3 mA corresponds to an air-fuel ratio equivalent to an air excess ratio of approximately 0.9. As compared to the curve 58, the peak current was suppressed to approximately 60%. In addition, the current value reached 0 mA approximately 23 seconds after the heater 24 was turned on. That is, as compared to the case no catalyst is supported, the peak current value of the negative current indicating the existence of combustible gas is significantly decreased and the delay before the gas sensor 30 is able to detect the components concentration of the ambient gas precisely is significantly decreased when the catalyst is composed of platinum alone.

The curve 62 indicates that a peak current of −0.22 mA indicating the existence of combustible gas, flowed approximately 12 seconds after the heater 24 was turned on A peak current of −0.22 mA corresponds to an air-fuel ratio equivalent to an air excess ratio of approximately 0.93. In addition, the current value reached a value close to 0 mA approximately 17 seconds after the heater 24 was turned on. That is, when the catalyst is composed of platinum and ruthenium, the peak current value of the negative current indicating the existence of combustible gas can be much smaller, thus the delay before the gas sensor 30 is able to detect the concentration of the combustible gas in the ambient gas precisely is much shorter than that when the catalyst is composed of platinum alone.

The curve 60 indicates that a peak current of −0.25 mA indicating the existence of combustible gas, flowed approximately 13 seconds after the heater 24 was turned on. A peak current of −0.25 mA corresponds to an air-fuel ratio equivalent to an air excess ratio of approximately 0.92. In addition, the current value reached a value close to 0 mA approximately 23 seconds after the heater 24 was turned on. That is, when the catalyst is composed of platinum and palladium, the peak current value of the negative current indicating the existence of combustible gas can be much smaller than that in the case where the catalyst is composed of platinum. Also, as in the case the catalyst is composed of platinum alone, the delay before the gas sensor 30 is able to detect the components concentration of the ambient gas precisely is significantly decreased.

The curve 66 indicates that a peak current of −0.3 mA indicating the existence of combustible gas, flowed approximately 11 seconds after the heater 24 was turned on. A peak current of −0.3 mA corresponds to an air-fuel ratio equivalent to an air excess ratio of approximately 0.9. In addition, the current value reached a value close to 0 mA approximately 17 seconds after the heater 24 was turned on. That is, when the catalyst is composed of platinum and rhodium, the peak current value of the negative current indicating the existence of combustible gas can be significantly decreased as in the case where the catalyst is composed of platinum. Also, the delay before the gas sensor 30 is able to detect the components concentration of the ambient gas precisely is much shorter than that when the catalyst is composed of platinum alone.

The above test results indicate that when the catalyst is composed of platinum and ruthenium or of platinum and palladium, the peak current value of the negative current indicating the existence of combustible gas can be much smaller than that in the case where the catalyst is composed of platinum. When the catalyst is composed of platinum and ruthenium or of platinum and rhodium, the delay before the gas sensor 30 is able to detect the components concentration of the ambient gas precisely is much shorter than that when the catalyst is composed of platinum alone.

Four of the gas sensors 30 as shown in First Example were prepared and four types of gas sensors 30 as shown in Table 1 were produced.

TABLE 1

| | Supported | Supported | | |
|---|---|---|---|---|
| | density α | density β | Current value X | Current value Y |
| Sample | (mg/cm³) | (mg/cm³) | (mA) | (mA) |
| 1 | 25 | 0 | 0.26 | — |
| 2 | 125 | 0 | 0.14 | 0.09 |
| 3 | 25 | 25 | 0.24 | — |
| 4 | 125 | 125 | 0.12 | 0.2 |

The supported density a represents the density of catalyst supported in the surface of the gas diffusion barrier 14 that faces ambient gas. The supported density β represents the density of catalyst supported in the surface of the gas diffusion barrier 14 that faces the detection chamber 17. The current value X was obtained as follows. The gas sensors 30 were exposed to a nitrogen gas atmosphere containing 100 ppm of 2-methoxyethanol, 10% of water vapor and 20% of oxygen for one hour. Then, under a 100% nitrogen gas atmosphere, a voltage of 0.45 V was applied to the power supply circuit 26 and the heater 24 was turned on. The absolute value of the negative current that flowed in the power supply circuit 26 at this time was measured. The current value Y was obtained as follows. The gas sensors 30 were exposed to a nitrogen gas atmosphere containing 100 ppm of 2-methoxyethanol, 10% of water vapor and 20% of oxygen for one hour. Then, the gas sensors 30 were left in atmosphere for 14 days. After that, under a 100% nitrogen gas atmosphere, a voltage of 0.45 V was applied to the power supply circuit 26 and the heater 24 was turned on. The absolute value of the positive current that flowed in the power supply circuit 26 was measured.

As for Sample 1 and Sample 2 shown in Table 1, before the catalyst layer 28 is formed, the gas sensors 30 was preliminarily heated to 100° C. and then a predetermined amount of chloroplatinic acid aqueous solution was instilled into the gas diffusion barrier 14. Immediately after that, the gas sensor 30 was dried at 100° C. Then, after the catalyst layer 28 was formed, the predetermined amount of chloroplatinic acid aqueous solution was instilled into the catalyst layer 28. As described above, gas sensors in which the density of catalyst supported (supported density α) was high on the side of the gas diffusion barrier 14 that faces ambient gas and the density of catalyst supported (supported density β) was low on the side of the gas diffusion barrier 14 that faces the detection chamber 17 were produced.

As for Sample 3 and Sample 4 shown in Table 1, the gas sensor 30 was left in atmosphere for one hour after a predetermined amount of chloroplatinic acid aqueous solution was instilled into the catalyst layer 28 and the gas diffusion barrier 14 of the gas sensor 30 so that the chloroplatinic acid aqueous solution could be dispersed uniformly over the entire gas diffusion barrier 14, and was then dried at 100° C. Therefore, the supported density α and the supported density β were equal to each other in Sample 3 and Sample 4. When Sample 1 and Sample 2 shown in Table 1 are compared, the absolute value of the negative current (current value X) was smaller for the one with higher density of supported catalyst. However, a small positive current (current value Y) was detected from Sample 2. When Sample 3 and Sample 4 shown in Table 1 are compared, the absolute value of the negative current (current value X) was smaller for the one with higher density of supported catalyst. However, a positive current (current value Y) was detected from Sample 4. When Sample 2 and Sample 4 are compared, there was no significant difference in the absolute value of the negative current (current value X). However, the absolute value of the positive current (current value Y) detected from Sample 4 was greater than that detected from Sample 2.

The results of this example indicate that when the density of catalyst supported on the side of the gas diffusion barrier 14 that faces ambient gas is relatively high and the density of catalyst supported on the side of the gas diffusion barrier 14 that faces the detection chamber 17 is relatively low, both the negative current that flows in the power supply circuit 26 and the positive current that flows in the power supply circuit 26 is controlled. That is, combustible components adsorbed in the gas diffusion barrier 14 react with oxygen sufficiently and adsorption of excess oxygen in the catalyst is prevented even when the gas sensor 30 is left in atmosphere for a long period of time.

While specific examples of the present invention have been described above, these examples are merely illustrative purpose and not intended to limit the claims. The art described in the claims includes various modifications of the specific examples described above. Although a gas sensor provided with a catalyst layer is described in the above examples, the catalyst layer is not necessarily required as long as a catalyst necessary for a reaction between organic compounds and oxygen is supported in the gas diffusion barrier. Also, although electrodes are formed on both sides of an unfired solid electrolyte by screen printing in the above examples, the method for forming the electrodes are not limited to the screen printing. For example, the electrodes may be formed in such a manner that masking is achieved on the surfaces of a fired solid electrolyte, on which the electrodes are not formed, and then sputtering or the like is achieved. The technologies described in this specification or the drawings may be used singly or in various combinations, and the combinations of the technologies are not limited to those described in the original claims.

1. A gas sensor comprising:
a gas diffusion barrier that supports a catalyst that promotes a reaction between oxygen and combustible components;
a plate-shaped solid electrolyte having conductivity of oxide ion; and
paired electrodes formed on surfaces of the solid electrolyte,
wherein one of the paired electrodes is located in a region into which ambient gas diffuses at a rate limited by the gas diffusion barrier and catalyzes a reaction between oxygen and combustible gas, the other paired electrode is located outside the region, the gas diffusion barrier supports a catalyst that promotes a reaction between oxygen and combustible components, and
the density of the catalyst supported on the side of the gas diffusion barrier that faces ambient gas is higher than the density of the catalyst supported on the side of the gas diffusion barrier that faces an detection chamber.

2. The gas sensor according to claim 1, wherein the combustible components is organic compounds.

3. The gas sensor according to claim 1, wherein the catalyst is formed of metal particles composed primarily of at least one metal element selected from the group consisting of platinum, ruthenium, palladium and rhodium.

4. The gas sensor according to claim 1, wherein the detection chamber is provided between the gas diffusion barrier and the solid electrolyte.

5. The gas sensor according to claim 1, wherein a catalyst-supporting layer is provided outside the gas diffusion barrier that faces ambient gas.

6. The gas sensor according to claim 5, wherein the catalyst-is supported in the gas diffusion barrier and the catalyst-supporting layer at a density in the range of 6.25 to 125 mg/cm³.

7. A fuel supply system comprising:
a gas sensor according to claim 1 provided with a heater that heats the gas sensor at a rate of approximately 30° C./sec of higher;
a current detection unit that detects an amount of current that flows between the paired electrodes; and
a control device for controlling the amount of fuel supplied based on the amount of current detected by the current detection unit.

8. A method for using a gas sensor according to claim 1, comprising:
heating the gas sensor up to a predetermined temperature at prescribed time intervals; and
reacting the combustible components adhered to the gas diffusion barrier with oxygen.

9. The gas sensor according to claim 2, wherein a catalyst-supporting layer is provided outside the gas diffusion barrier that faces ambient gas.

10. The gas sensor according to claim 3, wherein a catalyst-supporting layer is provided outside the gas diffusion barrier that faces ambient gas.

11. The gas sensor according to claim 4, wherein a catalyst-supporting layer is provided outside the gas diffusion barrier that faces ambient gas.
